(19) United States
(12) Patent Application Publication
(10) Pub. No.: US 2025/0244295 A1
(43) Pub. Date: Jul. 31, 2025

(54) BIOSENSOR AND PREPARATION METHOD

(71) Applicant: University of South Carolina, Columbia, SC (US)

(72) Inventors: Sourav Banerjee, Irmo, SC (US); Debdyuti Mandal, Cayce, SC (US)

(73) Assignee: University of South Carolina, Columbia, SC (US)

(21) Appl. No.: 19/034,186

(22) Filed: Jan. 22, 2025

Related U.S. Application Data
(60) Provisional application No. 63/626,684, filed on Jan. 30, 2024.

(51) Int. Cl. G01N 29/04; G01N 27/36

(52) U.S. Cl. CPC G01N 29/046; G01N 27/36; G01N 29/041

(57) ABSTRACT

The biosensor involves novel tone burst interdigitated transducer (TB-IDT) electrodes and multidirectional focused interdigitated electrodes for better sensitivity. The TB-IDT electrodes feature varied amplitude and width of electrode fingers over the length of the biosensor to cover a wider range of frequency access which does not rely on a single central frequency-based detection parameter. The multiple-frequency, multi-directional, and multi-amplitude accessibility reduces the occurrence of false-negatives and false-positives, leading to increased and improved sensitivity. The biosensor produces instantaneous diagnostic results and is highly sensitive in terms of broader bandwidth. The wide variety of compatible sensing receptors may be combined to accommodate detection of multiple target molecules using the same biosensor.

### CROSS-REFERENCE TO RELATED APPLICATIONS

This application claims the benefit of prior-filed, co-pending U.S. Provisional Patent Application No. 63/626,684, filed on Jan. 30, 2024, the contents of which are incorporated herein by reference in their entirety.

### STATEMENT REGARDING FEDERALLY SPONSORED RESEARCH OR DEVELOPMENT

This invention was made with government support under 2023-67022-40623 awarded by the Department of Agriculture. The government has certain rights in the invention.

### BACKGROUND OF THE INVENTION

The present application is directed to the field of sensing. More specifically, the present application is directed to the field of biosensing devices.

Biosensors have become a potent tool widely used for disease diagnostics and other healthcare, and for environmental and food safety monitoring. The early diagnosis of diseases can enhance preventive measures, increase the curability of the disease, and reduce healthcare costs. Although there are many conventional biosensors, they often suffer challenges in terms of sensitivity, detection time, and expense. The conventional sensors also use continuous waveform signals for detection which limits the window, making it less sensitive for information extraction.

One such biosensor uses electrode-based biosensing to detect surface acoustic waves (SAW) for economic and point-of-care (POC) biosensing. Conventional SAW-based biosensing often fails due to just one central frequency access, as the sensor can be less responsive to a particular mass-loading of the biomarkers due to destructive wave interferences because of the material type, wave modes generated, and the geometry of the sensing platform. These parameters can result in a particular mass-loading that can lead to highly undesirable false negatives.

It is therefore the object of this application to provide a sensor which covers a wider range of frequencies and does not rely on a single central frequency-based detection parameter.

### BRIEF SUMMARY OF THE INVENTION

The present application is for a biosensor device. The device includes a substrate comprising an anisotropic piezoelectric material, at least one input electrode located on the substrate, at least one output electrode located on the substrate, at least one sensing test bed located on the substrate between the at least one input electrode and the at least one output electrode, and at least one sensing receptor located on the at least one sensing test bed. The at least one sensing receptor is capable of binding with a target molecule to form a complex on the at least one sensing test bed.

In at least one embodiment of the device, the substrate is selected from the group consisting of: 36° Y-X lithium tantalate, Barium titanate, Langasite, Lead zirconate titanate, 128° Y-X axis Lithium niobate, Y-Z axis Lithium niobate, X-cut Lithium tantalate, Y-Z axis Lithium tantalate, PVDF film, ST-cut Quartz, and X-axis Quartz.

In at least one embodiment of the device, the at least one input electrode is a concentric circular interdigitated transducer.

In at least one embodiment of the device, the at least one input electrode has a central actuation frequency four times a central frequency of the at least one output electrode.

In at least one embodiment of the device, the at least one input electrode has a positive terminal and a negative terminal.

In at least one embodiment of the device, the at least one input electrode has a width and a spacing of one quarter of a wavelength (A) determined by the equation

$$λ = \frac{c}{f}$$

where c is an acoustic wave velocity in the substrate and f is a central frequency of the at least one input electrode.

In at least one embodiment of the device, the at least one input electrode is a tone-burst interdigitated transducer (TB-IDT) electrode or a focused interdigitated transducer (F-IDT) electrode.

In at least one embodiment of the device, the at least one sensing receptor is a bioreceptor used for detection of a target biomolecule.

The present application is also for a biosensor system. The system includes at least one biosensor device, as disclosed above, at least one signal generator connected to the at least one input electrode, and at least one signal receiver connected to the at least one output electrode.

In at least one embodiment of the system, the at least one signal generator transmits a tone burst signal to the at least one input electrode.

In at least one embodiment of the system, the at least one signal generator is a digital arbitrary function generator.

In at least one embodiment of the system, the at least one signal receiver is an oscilloscope.

At least one embodiment of the device also includes an analysis unit for performing data analysis of at least one signal received by the signal receiver.

The present application is also for a method of fabricating a biosensor device. The method includes depositing a first layer of silicon dioxide on a substrate, patterning the first layer of silicon dioxide with at least one sensing test bed, coating a first photoresist onto the first layer of silicon dioxide and baking the first photoresist, exposing the first photoresist to UV light using a first photomask; developing, rinsing, and drying the first photoresist, transferring a pattern of the first photoresist into the first layer of silicon dioxide layer by etching, depositing a second layer of silicon dioxide layer on the substrate, patterning the second layer of silicon dioxide, coating a second photoresist onto the second layer of silicon dioxide and baking the second photoresist, exposing the second photoresist to UV light using a second photomask, developing, rinsing, and drying the second photoresist, transferring a pattern of the second photoresist into the second layer of silicon dioxide layer by etching, fabricating a plurality of electrodes and a second layer of the at least one sensing test bed on the second layer of silicon dioxide layer by depositing at least one layer of metal on the second layer of silicon dioxide, patterning the second layer of silicon dioxide, coating a third photoresist onto the second layer of silicon dioxide and baking the third photoresist, exposing the third photoresist to UV light using a third photomask, developing, rinsing, and drying the third photoresist, and etching a pattern in the at least one layer of metal on the second layer of silicon dioxide. The substrate comprises an anisotropic piezoelectric material.

In at least one embodiment of the method, the first layer of silicon dioxide is deposited via plasma enhanced chemical vapor deposition (PECVD).

In at least one embodiment of the method, the first layer of silicon dioxide is patterned by spin coating a photoresist adhesion promotor.

In at least one embodiment of the method, the photoresist is exposed to UV light using a laser-printed photomask.

In at least one embodiment of the method, the resist pattern is transferred into one of the first silicon dioxide layer or the second silicon dioxide layer by etching in a buffered oxide etchant (BOE) solution.

In at least one embodiment of the method, the at least one layer of metal is deposited on the second layer of silicon dioxide via e-beam evaporation.

In at least one embodiment of the method, the at least one layer of metal is patterned via wet etching.

### BRIEF DESCRIPTION OF THE SEVERAL VIEWS OF THE DRAWING

FIG. 1a illustrates an exemplary biosensor system including at least one biosensor.

FIG. 1b illustrates an exemplary concentric circular IDT input electrode of the biosensor system.

FIG. 1c illustrates an exemplary IDT output electrode of the biosensor system.

FIGS. 2a through 2c illustrate a flowchart of a method used to create a biosensor.

It should be understood that, for clarity, not all elements are labeled in all drawings. Lack of labeling in a figure should not be interpreted as lack of a feature.

### DETAILED DESCRIPTION OF THE INVENTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Dimensions and materials identified in the drawings and applications are by way of example only and are not intended to limit the scope of the claimed invention. Any other dimensions and materials not consistent with the purpose of the present application can also be used. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

The present biosensor involves novel tone burst interdigitated transducer (TB-IDT) electrodes and multidirectional focused interdigitated electrodes for better sensitivity. The tone burst can be a sinusoidal signal coupled with the Hanning window function that consists of sensitive coda waves, which are actually utilized for better sensing. The TB-IDT electrodes feature varied amplitude and width of electrode fingers over the length of the biosensor to cover a wider range of frequency access which does not rely on a single central frequency-based detection parameter. The multiple-frequency, multi-directional, and multi-amplitude accessibility reduces the occurrences of false-negatives and -positives, leading to increased and improved sensitivity. The biosensor produces instantaneous diagnostic results and is highly sensitive in terms of broader bandwidth.

The biosensor system 100 includes at least one biosensor 110 operably connected to at least one controller 120. The biosensor 110 includes a substrate 111 on which is arranged at least one input electrode 113 and at least one output electrode 116. The input electrode 113 receives at least one input electrical signal from the controller 120 and converts the input electrical signal to at least one mechanical signal, such as, but not limited to, waves traveling along and/or through the substrate 111. The mechanical signal propagates across a sensory testing bed 117 in the substrate 111 to the output electrode 116. The output electrode 116 receives the mechanical signal and converts the mechanical signal to at least one output electrical signal. The output electrical signal is received by the controller 120, which performs analysis of the output electrical signal(s) as compared to the original input electrical signal to determine the properties of the substance in the sensory testing bed 117.

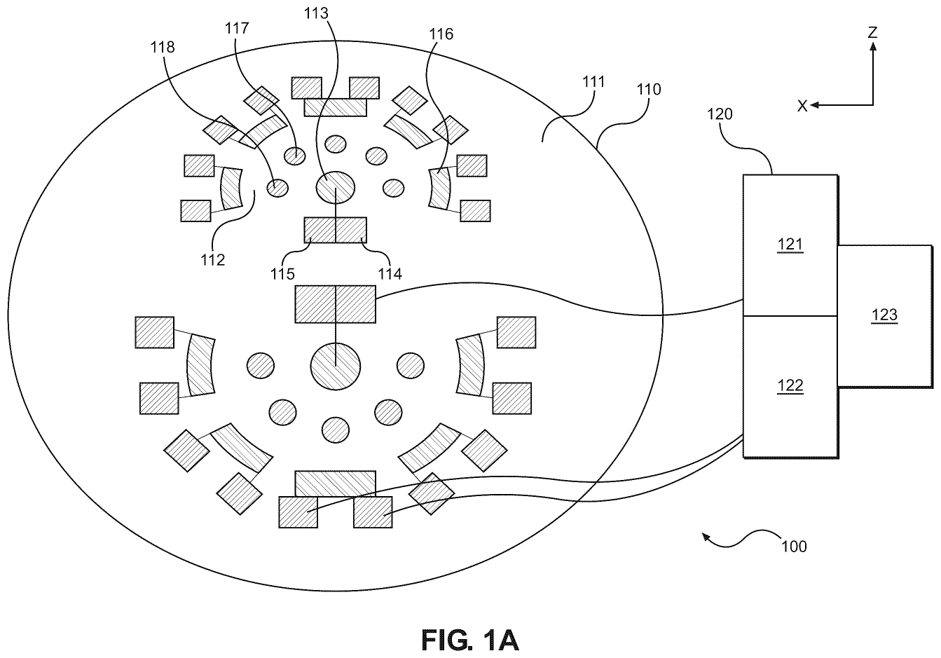

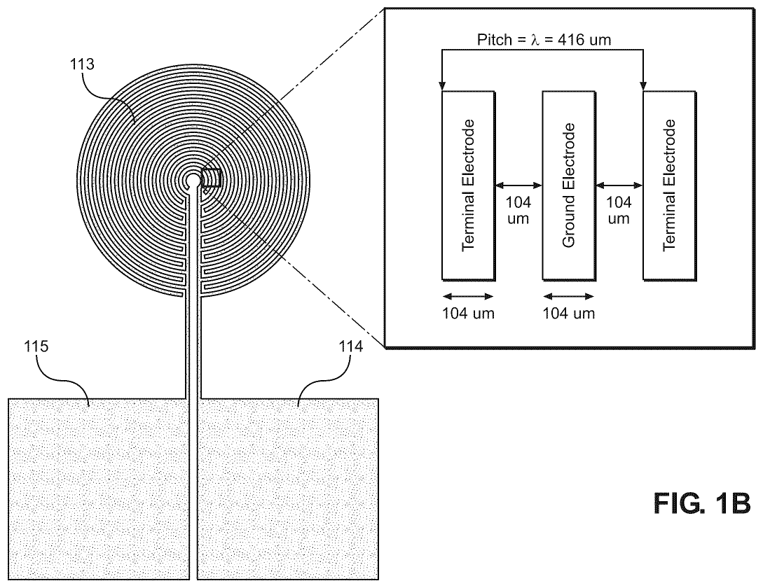

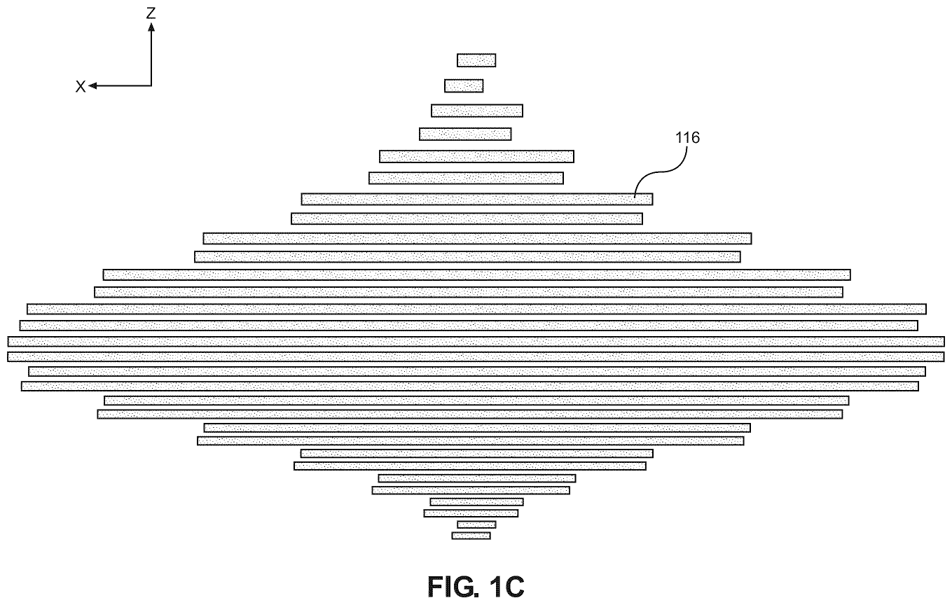

The substrate 111 is a piezoelectric material which is essentially anisotropic, i.e. wave propagation along different directions of the substrate 111 results in different acoustic velocities. In the embodiment shown in FIG. 1a, the substrate 111 is a 36° YX lithium tantalate piezoelectrical material. This substrate 111 generates transversely polarized or shear horizontal (SH) waves along the substrate's X-direction and Rayleigh waves along the orthogonal directions while saturating a significant part of the thickness of the substrate 111. The biosensor 110 further incorporates a waveguide layer 112 which results in the formation of Love waves, which are very sensitive—corresponding to the slightest of mass loading. The SH waves have limited normal displacement on the surface of the substrate 111 and thus does not decay under liquid media. This can be useful in the field of biosensing and chemical sensing.

In other embodiments, the substrate 111 comprises other piezoelectric materials known in the art. Such piezoelectric materials may include, but are not limited to, Barium titanate, Langasite, Lead zirconate titanate (PZT), 128° Y-X axis Lithium niobate, Y-Z axis Lithium niobate, X-cut Lithium tantalate, Y-Z axis Lithium tantalate, PVDF film, ST-cut Quartz, or X-axis Quartz.

The input electrode 113 is a concentric circular interdigitated transducer (IDT) electrode which is designed as an actuator at the approximate center of the substrate 111. The concentric circular IDT input electrode 113 produces omni-directional wavefronts within the same plane to access different directions of wave propagation. Omni-directional wavefronts allow generation and extraction of different wave features in different directions due to the anisotropy of the substrate 111, thereby increasing the chances of higher sensitivity. The concentric circular IDT input electrode 113 shown in FIG. 1b has a positive terminal 114 and a negative terminal 115 with two similar width spacing within one pitch of the IDT, hence the width and the spacing is ¼th of the wavelength derived in the below equation using the acoustic wave velocity of the substrate 111 and the central frequency of the concentric circular IDT input electrode 113.

By way of non-limiting example, in the lithium tantalate substrate 111 of FIG. 1a, the acoustic wave velocity is 4160 m/s. The concentric circular IDT input electrode 113 shown in FIG. 1a is built at central actuation frequency of 10 MHz, four times the central frequency of the output electrodes 116. Using an exemplary central frequency of 10 MHz, the wavelength (A) for the width spacing of the concentric circular IDT input electrode 113 is determined using acoustic wave velocity (c) and central frequency (f) in the equation:

$$λ = \frac{c}{f}$$

Using the above equation, the wavelength is derived as 416 micrometers, resulting in a width spacing of 104 micrometers for the embodiment of the concentric circular IDT input electrode 113 shown in FIGS. 1a and 1b. Other embodiments with different acoustic wave velocities of the substrate 111 and/or different central frequencies of the concentric circular IDT input electrode 113 may therefore have different wavelengths and correspondingly different width spacings of the concentric circular IDT input electrode 113.

During use, the concentric circular IDT input electrode 113 is actuated by a tone burst signal instead of a conventional continuous signal. In one embodiment, the tone burst signal is a 5-count tone burst signal.

The output electrodes 116 are IDT electrodes as shown in FIGS. 1a and 1c. The output electrodes 116 may be tone-burst IDT (TB-IDT) electrodes, focused IDT (F-IDT) electrodes, or a combination thereof depending on the properties of the substrate 111. The TB-IDT electrodes have broader frequency enabling wider frequency spectrum access along with varied amplitude configuration of the output electrodes 116. As shown in FIG. 1c, the TB-IDT electrodes used as output electrodes 116 include multiple pairs of electrodes within the frequency range selected. The width and height of the paired electrodes are derived based on the frequencies and their corresponding amplitudes. The individual width of the paired electrodes is one-quarter of the wavelength corresponding to each frequency within the frequency range selected. For the aperture or the height of the paired electrodes, the frequency domain curve is normalized with respect to the maximum peak amplitude. Under the curve, 20 times wavelength span corresponding to all the respective frequencies is demonstrated for the half aperture. The aperture length is doubled to construct the TB-IDT electrode.

The embodiment shown in FIG. 1a includes multiple output electrodes 116 surrounding multiple input electrodes 113 at a distance from the outer periphery of the input electrodes. The distance is an integer multiplier of the wavelength A derived above. In the embodiment shown in FIG. 1a, the distance is 30*A. The embodiment shown in FIG. 1a also shows output electrodes 116a, 116b, 116c, 116d, and 116e at angular locations 0°, 45°, 90°, 135°, and 180°, respectively, relative to each input electrode 113. In this embodiment, output electrodes 116a, 116b, 116d, and 116e are F-IDT electrodes while output electrode 116c is a TB-IDT electrode. As Rayleigh waves were observed along the 90° location (Z-direction), the output electrode 116c (TB-IDT electrode) is placed in this direction, as a TB-IDT electrode is a multi-frequency and multi-amplitude accessing electrode.

It should be appreciated that each different material used for substrate 111 can utilize different numbers and selections of output electrodes 116. Due to the anisotropic nature of the substrate 111, different transmission directions result in different phase velocities with different modal domination. Additionally, different geometrical configurations of the interdigitated electrodes and boundaries can result in different resonating frequencies and the formation of different acoustic wave modes. Thus, the different configurations of the output electrodes 116 may be sensed for resonance by exciting the input electrode 113 into a large range of frequencies based on their tuning responses. The process is referred to as “frequency tuning” corresponding to each configuration of the interdigitated electrodes.

A separate sensing test bed 117 is located between the input electrode 113 and each output electrode 116. As shown in FIG. 1a, output electrodes 116a, 116b, 116c, 116d, and 116e each measure the response of sensing test beds 117a, 117b, 117c, 117d, and 117e, respectively. The sensing test beds 117 include sensing receptors 118 which are used for the specific detection of a target molecule. In certain embodiments, the sensing receptors 118 are bioreceptors used for the specific detection of a target biomolecule. Different sensing test beds 117 may include the same sensing receptors 118, different sensing receptors 118 for detection of different target molecules, different sensing receptors 118 for the same target molecule, or any combination thereof. Sensing receptors 118 can be enzymes, antibodies, molecular-imprinted polymers, or any other sensing receptor known in the art used to detect antigens, DNA, proteins, spores, or any other target molecule known in the art. In use, the sensing receptors 118 form a complex with the target biomolecule which increases mass loading on the substrate 111. The increased mass loading affects mechanical signal propagation through the substrate 111.

The controller section 120 of the system 100 comprises at least one signal generator 121 connected to the input electrode 113 and at least one signal receiver 122 connected to the output electrode 116. It should be appreciated that the signal generator 121 and signal receiver 122 may be a combined unit or separate units. In the embodiment shown in FIG. 1, the signal generator 121 comprises a digital arbitrary function generator, while the signal receiver 122 is an oscilloscope. In various embodiments, the controller section 120 also includes at least one analysis unit 123 for performing data analysis of at least one signal received by signal receiver 122. The analysis unit 123 may be connected to the signal receiver 122 or a separate unit.

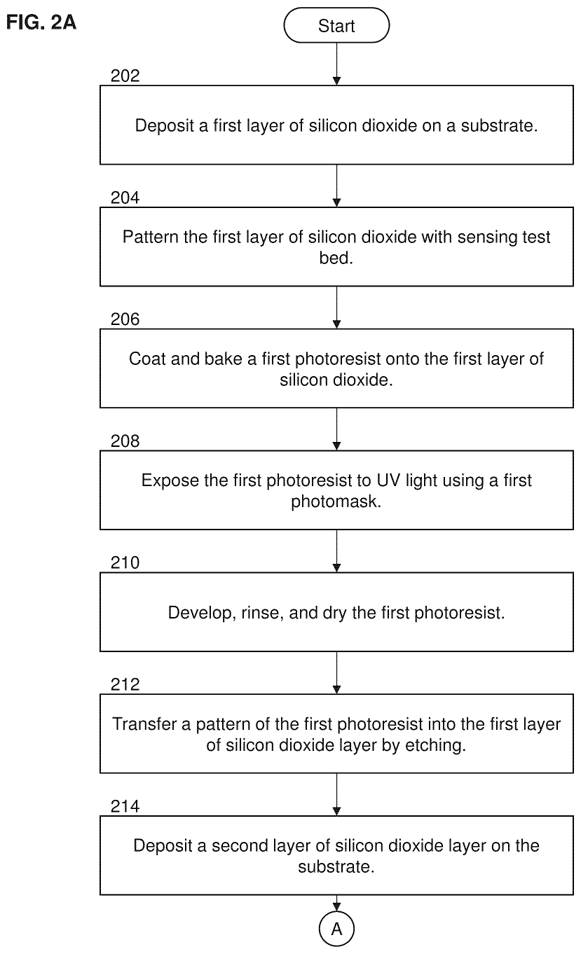

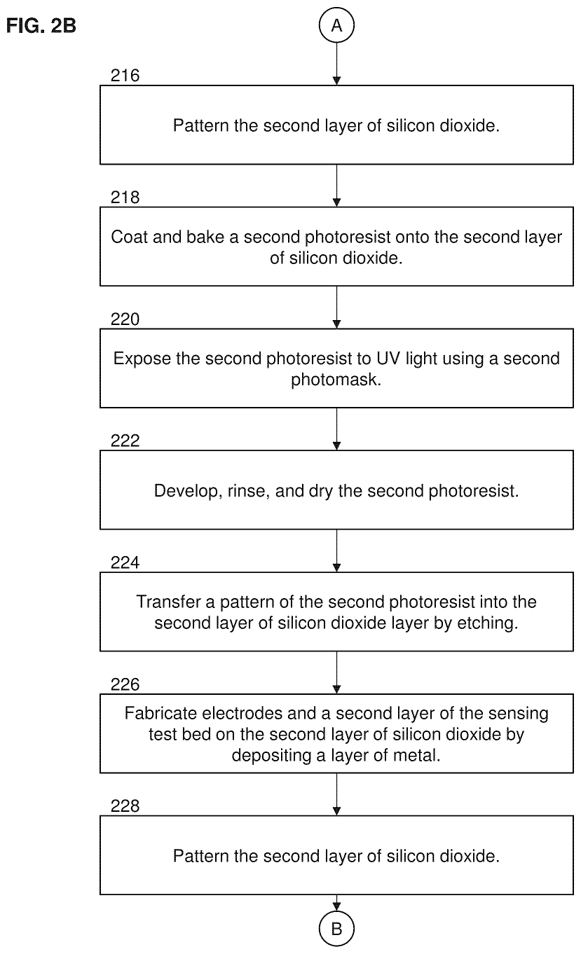

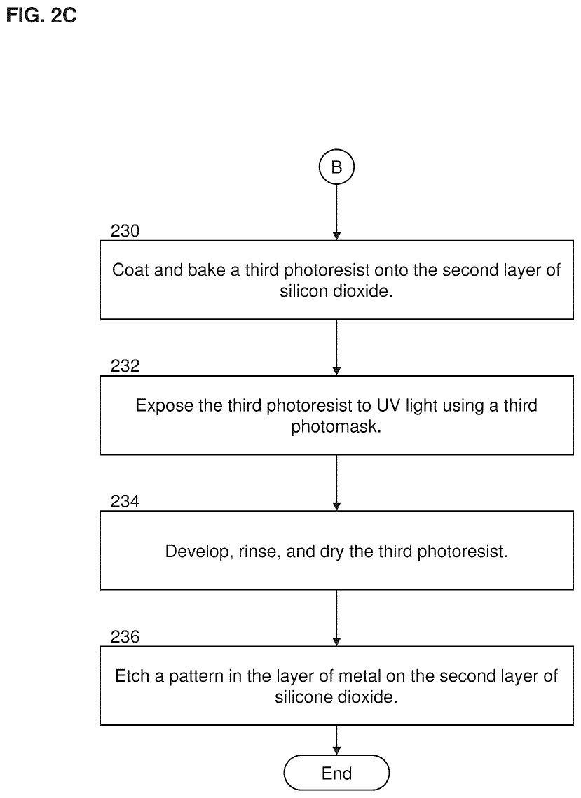

FIGS. 2a through 2c illustrate a flowchart of method 200 used to create the biosensor 110. It should be understood that these are not necessarily performed in this order, and that, depending on the desired configuration of biosensor 110, certain parts of the method 200 may be optional.

In block 202, a silicon dioxide (SiO2) layer is deposited on the substrate 111. In one embodiment, a 1.2 microns thick silicon dioxide layer was deposited via SiO plasma enhanced chemical vapor deposition (PECVD) onto a bare 100 mm, 36° YX cut-LiTaO3 SAW Grade substrate 111. The PECVD is performed at 200° C., 25W plasma power, and 800 mTorr using 2% Silane (balanced He) and N2O. Additional care may be taken to avoid excessive stress and possible cracking of the piezoelectric substrates by slowly ramping up and down the chamber temperature. Temperature change less than 10° C./min may be sufficient to avoid damaging the substrate 111. This ramping rate can also be used for subsequent photoresist baking blocks.

In blocks 204 through 212, the first silicon dioxide layer is patterned using photolithography and wet etching to create the first layer of the sensory testing beds 117.

In block 204, the silicon dioxide layer is patterned. In one embodiment, the silicon dioxide layer is patterned by spin coating a photoresist adhesion promotor. In certain embodiments, photoresist adhesion promotor is 20% hexamethyldisiloxane (HMDS) and 80% propylene glycol monomethyl acetate (PGMA) solution, applied at 3000 rpm for 40 seconds.

In block 206, a photoresist is then coated onto the silicon dioxide layer and baked. In certain embodiments, an S1813 positive photoresist is spin coated at 3000 rpm for 40 seconds and baked at 110° C. for 1 min.

In block 208, the photoresist is exposed to UV light using a photomask. In certain embodiments, the photoresist is exposed to UV light with a dose of 120 mJ/cm2 using a laser-printed photomask.

In block 210, the exposed resist is developed, rinsed, and dried. In certain embodiments, the exposed resist is developed in MF-319 developer for 2 minutes, rinsed with deionized water, and dried with N2.

In block 212, the resist pattern is transferred into the underlying silicon dioxide layer by etching. In certain embodiments, the resist pattern is transferred into the underlying 1.2 microns silicon dioxide layer by etching in a buffered oxide etchant (BOE) 10:1 solution. The etch rate of the oxide layer is approximately 300 nm/min.

In block 214, a second silicon dioxide layer is deposited on the substrate 111. In one embodiment, the second silicon dioxide layer is 50 nm thick. This second silicon dioxide layers acts as a mask for the aperture of the tone burst interdigitated transducers (TB-IDTs) that are defined in the next fabrication block.

In blocks 216, 218, 220, 222, and 224, the second silicon dioxide layer is patterned using the lithography and etching method previously described in blocks 204, 206, 208, 210, and 212.

In block 226, the electrodes 113 and 116 and the second layer of the sensing test beds 117 (which function as sensing membranes) are fabricated by deposition of at least one layer of metal. In certain embodiments, fabrication comprises deposition via e-beam evaporation. In one embodiment, the e-beam evaporation deposits a chromium (Cr) adhesion layer followed by a layer of gold (Au). One embodiment utilizes a 10 nm Cr layer and a 100 nm Au layer.

In blocks 228, 230, 232, and 234, the second silicon dioxide layer is further patterned using the lithography procedure previously described in blocks 204, 206, 208, and 210. It should be noted that alignment of the photomask to the 50 nm silicon dioxide aperture for the TB-IDT is critical, and hence care was taken before exposing to the photoresist.

In block 236, patterns are etched in the at least one layer of metal. In one embodiment, gold and/or chromium patterns were defined via wet etching. In one embodiment, wet etching of the gold layer was performed by using an I2/KI gold etch solution. In another embodiment, wet etching of the chromium layer was performed by using a nitric acid/ceric ammonium nitrate chromium etch solution.

It is to be understood that this written description uses examples to disclose the invention, including the best mode, and also to enable any person skilled in the art to make anew the invention. The various embodiments of the invention may be combined in any arrangement capable of producing a biosensor. Any dimensions or other size descriptions are provided for purposes of illustration and are not intended to limit the scope of the claimed invention. Additional embodiments can include variations component composition, synthesis, and combination, as well as variations required for use in the industry. The patentable scope of the invention may include other examples that occur to those skilled in the art.

What is claimed is:

1. A biosensor device, comprising:
a substrate comprising an anisotropic piezoelectric material;
at least one input electrode located on the substrate;
at least one output electrode located on the substrate;
at least one sensing test bed located on the substrate between the at least one input electrode and the at least one output electrode; and
at least one sensing receptor located on the at least one sensing test bed, wherein the at least one sensing receptor is capable of binding with a target molecule to form a complex on the at least one sensing test bed.

2. The device of claim 1, wherein the substrate is selected from the group consisting of: 36° Y-X lithium tantalate, Barium titanate, Langasite, Lead zirconate titanate, 128° Y-X axis Lithium niobate, Y-Z axis Lithium niobate, X-cut Lithium tantalate, Y-Z axis Lithium tantalate, PVDF film, ST-cut Quartz, and X-axis Quartz.

3. The device of claim 1, wherein the at least one input electrode is a concentric circular interdigitated transducer.

4. The device of claim 1, wherein the at least one input electrode has a central actuation frequency four times a central frequency of the at least one output electrode.

5. The device of claim 1, wherein the at least one input electrode has a positive terminal and a negative terminal.

6. The device of claim 1, wherein the at least one input electrode has a width and a spacing of one quarter of a wavelength (λ) determined by the equation:
$$λ = \frac{c}{f}$$
where c is an acoustic wave velocity in the substrate and f is a central frequency of the at least one input electrode.

7. The device of claim 1, wherein the at least one input electrode is a tone-burst interdigitated transducer (TB-IDT) electrode or a focused interdigitated transducer (F-IDT) electrode.

8. The device of claim 1, wherein the at least one sensing receptor is a bioreceptor used for detection of a target biomolecule.

9. A biosensor system, comprising:
at least one biosensor device, comprising:
a substrate comprising an anisotropic piezoelectric material,
at least one input electrode located on the substrate,
at least one output electrode located on the substrate,
at least one sensing test bed located on the substrate between the at least one input electrode and the at least one output electrode, and
at least one sensing receptor located on the at least one sensing test bed, wherein the at least one sensing receptor is capable of binding with a target molecule to form a complex on the at least one sensing test bed;
at least one signal generator connected to the at least one input electrode; and
at least one signal receiver connected to the at least one output electrode.

10. The system of claim 9, wherein the at least one signal generator transmits a tone burst signal to the at least one input electrode.

11. The system of claim 9, wherein the at least one signal generator is a digital arbitrary function generator.

12. The system of claim 9, wherein the at least one signal receiver is an oscilloscope.

13. The system of claim 9, further comprising an analysis unit for performing data analysis of at least one signal received by the signal receiver.

14. A method of fabricating a biosensor device, comprising:
depositing a first layer of silicon dioxide on a substrate, wherein the substrate comprises an anisotropic piezoelectric material;
patterning the first layer of silicon dioxide with at least one sensing test bed;
coating a first photoresist onto the first layer of silicon dioxide and baking the first photoresist;
exposing the first photoresist to UV light using a first photomask;
developing, rinsing, and drying the first photoresist;
transferring a pattern of the first photoresist into the first layer of silicon dioxide layer by etching;
depositing a second layer of silicon dioxide layer on the substrate;
patterning the second layer of silicon dioxide;
coating a second photoresist onto the second layer of silicon dioxide and baking the second photoresist;
exposing the second photoresist to UV light using a second photomask;
developing, rinsing, and drying the second photoresist;
transferring a pattern of the second photoresist into the second layer of silicon dioxide layer by etching;
fabricating a plurality of electrodes and a second layer of the at least one sensing test bed on the second layer of silicon dioxide layer by depositing at least one layer of metal on the second layer of silicon dioxide;
patterning the second layer of silicon dioxide;
coating a third photoresist onto the second layer of silicon dioxide and baking the third photoresist;
exposing the third photoresist to UV light using a third photomask;
developing, rinsing, and drying the third photoresist; and
etching a pattern in the at least one layer of metal on the second layer of silicon dioxide.

15. The method of claim 14, wherein the first layer of silicon dioxide is deposited via plasma enhanced chemical vapor deposition (PECVD).

16. The method of claim 14, wherein the first layer of silicon dioxide is patterned by spin coating a photoresist adhesion promotor.

17. The method of claim 14, wherein the photoresist is exposed to UV light using a laser-printed photomask.

18. The method of claim 14, wherein the resist pattern is transferred into one of the first silicon dioxide layer or the second silicon dioxide layer by etching in a buffered oxide etchant (BOE) solution.

19. The method of claim 14, wherein the at least one layer of metal is deposited on the second layer of silicon dioxide via e-beam evaporation.

20. The method of claim 19, wherein the at least one layer of metal is patterned via wet etching.
